(19) United States
(12) Patent Application Publication
(10) Pub. No.: US 2026/0244882 A1
(43) Pub. Date: Aug. 20, 2026

(54) METHOD, APPARATUS, DEVICE AND MEDIUM FOR TRANSLATION FROM SOURCE LANGUAGE TO DESTINATION LANGUAGE

(71) Applicants: Beijing Youzhuju Network Technology Co., Ltd., Beijing (CN); Bytedance Technology Ltd., Grand Cayman (KY)

(72) Inventors: Ting Xu, Hong Kong (CN); Zhichao Huang, Hong Kong (CN); Jiankai Sun, Hong Kong (CN); Shanbo Cheng, Singapore (SG)

(21) Appl. No.: 19/396,201

(22) Filed: Nov. 20, 2025

(30) Foreign Application Priority Data
Feb. 17, 2025 (CN) 202510173987.5

(51) Int. Cl. G06F 40/58; G06F 40/51

(52) U.S. Cl. CPC G06F 40/58; G06F 40/51

(57) ABSTRACT

A method, an apparatus, a device, and a medium for translation from a source language to a destination language are provided. In the method, in response to receiving a data sequence represented in a source language, a data segment is determined from the data sequence, the data segment including at least one data unit. A translation strategy for translating the data segment is determined using a machine learning model, the translation strategy indicating a target part to be translated in the data segment. A translation result corresponding to the target part is determined using the machine learning model based on the translation strategy, the translation result being represented in a destination language.

### CROSS-REFERENCE

The present application claims the priority of Chinese Patent Application No. 202510173987.5, filed on Feb. 17, 2025, and entitled “Method, Apparatus, Device and Medium for Translation from Source Language to Destination language”, which is incorporated herein by reference in its entirety.

### FIELD

Implementations of the present disclosure generally relate to natural language translation, and in particular, to a method, an apparatus, a device, and a computer-readable storage medium for translation from a source language to a destination language.

### BACKGROUND

Machine learning techniques have been widely used for natural language translation, and machine learning models dedicated to simultaneous translation have been developed. In the process of simultaneous translation, input data is received in a streaming manner, and the machine learning model gradually outputs translation results corresponding to newly received parts. However, because the machine learning model cannot obtain a complete input sentence in the process of simultaneous translation, errors may occur in the translation results that are gradually output. In this case, it is desired to perform simultaneous translation in a more efficient manner.

### SUMMARY

In a first aspect of the present disclosure, there is provided a method for translation from a source language to a destination language. In the method, in response to receiving a data sequence represented in the source language, a data segment is determined from the data sequence, the data segment including at least one data unit. A translation strategy for translating the data segment is determined using a machine learning model, the translation strategy indicating a target part to be translated in the data segment. A translation result corresponding to the target part is determined using the machine learning model based on the translation strategy, the translation result being represented in the destination language.

In a second aspect of the present disclosure, there is provided an apparatus for translation from a source language to a destination language. The apparatus includes: a segment determination module configured to, in response to receiving a data sequence represented in the source language, determine a data segment from the data sequence, the data segment including at least one data unit; a strategy determination module configured to determine a translation strategy for translating the data segment using a machine learning model, the translation strategy indicating a target part to be translated in the data segment; and a result determination module configured to determine a translation result corresponding to the target part using the machine learning model based on the translation strategy, the translation result being represented in the destination language.

In a third aspect of the present disclosure, there is provided an electronic device. The electronic device includes: at least one processor; and at least one memory, the at least one memory being coupled to the at least one processor and storing instructions for execution by the at least one processor, the instructions, when executed by the at least one processor, causing the electronic device to perform the method according to the first aspect.

In a fourth aspect of the present disclosure, there is provided a computer-readable storage medium having a computer program stored thereon, the computer program, when executed by a processor, causing the processor to implement the method according to the first aspect.

In a fifth aspect of the present disclosure, there is provided a computer program product including a computer program, the computer program, when executed by a processor, implementing the method according to the first aspect.

It may be understood that the content described in the Summary section of the present disclosure is neither intended to identify key or essential features of the implementations of the present disclosure, nor is it intended to be used to limit the scope of the present disclosure. Other features of the present disclosure would be readily envisaged through the following description.

### BRIEF DESCRIPTION OF THE DRAWINGS

The above and other features, advantages, and aspects of the implementations of the present disclosure will become more apparent in the following description, taken in conjunction with the drawings and with reference to the following detailed description. In the drawings, the same or similar reference symbols refer to the same or similar elements, where:

FIG. 1 illustrates a block diagram of a simultaneous translation process according to an implementation of the present disclosure;

FIG. 2 illustrates a block diagram of a process for translation from a source language to a destination language according to some implementations of the present disclosure;

FIG. 3 illustrates a block diagram of generation of a prompt using a prompt template according to some implementations of the present disclosure;

FIG. 4 illustrates a block diagram of a translation process performed in a plurality of steps according to some implementations of the present disclosure;

FIG. 5 illustrates a block diagram of training of a machine learning model according to some implementations of the present disclosure;

FIG. 6 illustrates a block diagram of determination of a translation result using a machine learning model according to some implementations of the present disclosure;

FIG. 7 illustrates a flowchart of a method for translation from a source language to a destination language according to some implementations of the present disclosure;

FIG. 8 illustrates a block diagram of an apparatus for translation from a source language to a destination language according to some implementations of the present disclosure; and

FIG. 9 illustrates a block diagram of a device capable of implementing a plurality of implementations of the present disclosure.

### DETAILED DESCRIPTION

The implementations of the present disclosure are described in more detail below with reference to the drawings. Although some implementations of the present disclosure are shown in the drawings, It may be understood that the present disclosure may be implemented in various forms and should not be construed as limited to the implementations set forth herein. Instead, these implementations are provided for a more thorough and complete understanding of the present disclosure. It may be understood that the drawings and implementations of the present disclosure are only for illustrative purposes and are not intended to limit the scope of protection of the present disclosure.

In the description of the implementations of the present disclosure, the term “include/comprise” and similar terms thereof are to be construed as open-ended inclusions, that is, “include/comprise but not limited to”. The term “based on” is to be construed as “at least partially based on”. The term “an implementation” or “the implementation” is to be construed as “at least one implementation”. The term “some implementations” is to be construed as “at least some implementations”. Other definitions, either explicit or implicit, may be included below. As used herein, the term “model” may represent an association between various data. For example, the association may be obtained based on various technical solutions that are currently known and/or will be developed in the future.

It may be understood that the data involved in the technical solution (including but not limited to the data itself, acquisition or use of the data) should comply with requirements of corresponding laws, regulations, and related provisions.

It may be understood that before the use of the technical solution disclosed in the embodiments of the present disclosure, the user should be informed of the type, range of use, use scenarios, etc., of personal information involved in the present disclosure and the authorization of the user should be obtained in an appropriate manner in accordance with relevant laws and regulations.

For example, in response to receiving an active request from a user, prompt information is sent to the user to clearly inform the user that the requested operation will require access to and use of personal information of the user. In this way, the user may independently choose, based on the prompt information, whether to provide the personal information to software or hardware, such as an electronic device, an application, a server, or a storage medium, that performs the operations of the technical solution of the present disclosure.

As an optional but non-limiting implementation, in response to receiving the active request from the user, the prompt information may be sent to the user in the form of, for example, a pop-up window, in which the prompt information may be presented in text. Furthermore, the pop-up window may also include a selection control for the user to select whether to “agree” or “disagree” to provide the personal information to the electronic device.

It may be understood that the above process of notifying and obtaining the authorization of the user is only illustrative and does not constitute a limitation on the implementations of the present disclosure, and other manners that satisfy the relevant laws and regulations may also be applied to the implementations of the present disclosure.

The term “in response to” used herein represents a state in which a corresponding event occurs or a condition is satisfied. It may be understood that there is not necessarily a strong correlation between the timing of the execution of a subsequent action performed in response to the event or condition and the time at which the event occurs or the condition is satisfied. For example, in some cases, the subsequent action may be performed immediately when the event occurs or the condition is satisfied, while in other cases, the subsequent action may be performed after a period of time after the event occurs or the condition is satisfied.

### Example Environment

Machine learning models dedicated to simultaneous machine translation (abbreviated as SiMT) have been developed. In the process of SiMT, input data represented in a source language may be translated into a translation result represented in a destination language. The input data is received in a streaming manner, and the machine learning model gradually outputs translation results corresponding to newly received parts. However, because the machine learning model cannot obtain a complete input sentence in the process of simultaneous translation, errors may occur in the translation results that are gradually output. For ease of discussion, in the context of the present disclosure, the translation process is described using an example in which the source language is Chinese and the destination language is English. Alternatively, and/or in addition, the source language and the destination language may include other natural languages.

Although technical solutions of using machine learning models to perform SiMT have been proposed, the existing technical solutions usually perform SiMT in a sequential manner and use prefix-aligned data to query a pre-trained large language model to generate partial translations. However, the accuracy of the translation results of such machine learning models is not satisfactory. In order to improve the accuracy of machine learning models, reinforcement learning technical solutions have been proposed. However, the traditional reinforcement learning from human feedback (abbreviated as RLHF) methods are only applicable to single-step processing. SiMT receives data input in the streaming manner in a multi-step manner, that is, the input data to be translated is received step by step. The dynamic change of the input data brings challenges to SiMT. For example, a word or phrase may have multiple meanings, and translating all the received text segments in a single step may lead to incorrect parsing of sentence components, which in turn leads to translation errors.

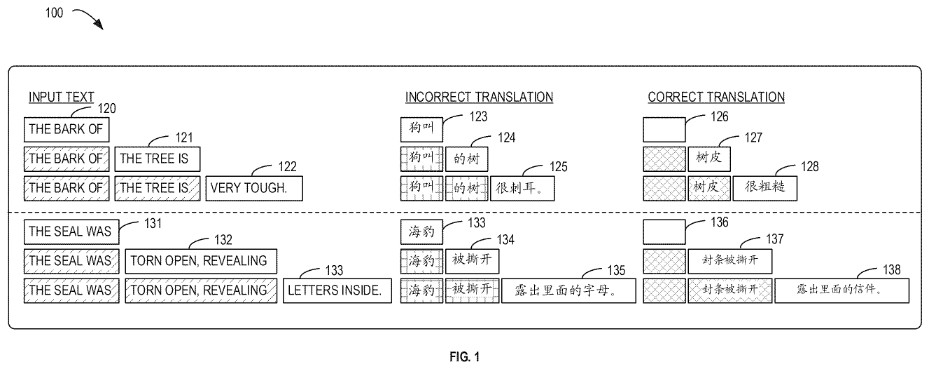

An overview of a simultaneous translation process is described with reference to FIG. 1, which illustrates a block diagram 100 of a simultaneous translation process according to an implementation of the present disclosure. The upper part of FIG. 1 shows that an input text “the bark of the tree is very tough” is received step by step in a streaming manner. The input data is fed to the machine learning model in a sequential manner, and the machine learning model receives a new text segment at each step and generates a corresponding translation. The translation result at the current step may affect subsequent translations.

As shown in FIG. 1, blank blocks 120, 121, and 122 represent new input texts at the current step, and striped blocks represent input texts at the previous step. The right side of FIG. 1 shows examples of an incorrect translation and a correct translation, respectively. In the incorrect translation, blank blocks 123, 124, and 125 represent translation results for the new input texts in each step (block 123 corresponds to block 120, block 124 corresponds to block 121, and block 125 corresponds to block 122). The mesh blocks before the blank blocks 123, 124, and 125 represent previous translation results, respectively. It may be seen that “the bark of” is incorrectly translated as “the bark of a dog” due to incorrect parsing of sentence components.

It is desired to generate a correct translation as shown on the right side of FIG. 1. Blank blocks 126, 127, and 128 represent translation results for the new input texts, respectively (block 126 corresponds to block 120, block 127 corresponds to block 121, and block 128 corresponds to block 122), and the shaded blocks before the blank blocks 126, 127, and 128 represent previous translation results, respectively. At this point, in step 1, “the bark of” is not translated (block 126 is empty); instead, “the bark of” and “the tree is” are translated as “tree bark” in step 2. In this way, the correct translation of “the bark of the tree is very tough” may be output.

Similarly, the lower part of FIG. 1 shows the translation process for another input text “the seal was torn open, reveling letters inside”. Blank blocks 130, 131, and 132 represent new input texts at the current step, and striped blocks represent input texts at the previous step. In the incorrect translation, blank blocks 133, 134, and 135 represent translation results for the new input texts, respectively (block 133 corresponds to block 130, block 134 corresponds to block 131, and block 135 corresponds to block 132), and the mesh blocks before the blank blocks 133, 134, and 135 represent previous translation results, respectively. It may be seen that “the seal was” is incorrectly translated as “seal” due to incorrect parsing of sentence components.

It is desired to generate a correct translation as shown on the right side of FIG. 1. Blank blocks 136, 137, and 138 represent translation results for the new input texts, respectively (block 136 corresponds to block 130, block 137 corresponds to block 131, and block 138 corresponds to block 132), and the shaded blocks before the blank blocks 136, 137, and 138 represent previous translation results, respectively. At this point, in step 1, “the seal was” is not translated (block 136 is empty); instead, “the seal was” and “torn open, reveling” are translated as “the seal was torn open” in step 2. In this way, the correct translation of “the seal was torn open, reveling letters inside” may be output.

Furthermore, a technical solution for applying reinforcement learning to SiMT has been proposed. However, this technical solution uses two models: a full sentence translation model and a read/write policy model. The full sentence translation model is trained with full sentence translation samples (text pairs in the source language and a template language), and the read/write policy is designed to process the current input text and determine when to call the translation model. These technical solutions only focus on training the read/write policy, and cannot train the translation model to adapt to the input data of the dynamic evolution SiMT. In this case, it is desired to perform simultaneous translation in a more efficient manner.

### Overview of Text Translation

In order to at least partially address the deficiencies in the prior art, according to an implementation of the present disclosure, a translation method for translation from a source language to a destination language is proposed. In the present disclosure, the model may determine to wait for additional context input or directly translate the current input at each translation step, and dynamically adjust based on the current input and existing translation results. Specifically, the present disclosure proposes a new reinforcement learning framework: Sequential Policy Optimization for Simultaneous Machine Translation (abbreviated as SeqPO-SiMT), which redefines the simulated machine translation task as a sequential decision problem and optimizes the language model to jointly optimize the translation quality and latency of SiMT.

According to some implementations of the present disclosure, SiMT may be redefined as a sequential decision process that actively interacts with a dynamic environment. The present disclosure may use a language model to provide the functions of a translation model and a read/write policy. The present disclosure divides a complete sentence into multiple segments and feeds these segments to the language model in a streaming manner, thereby enabling the language model to effectively monitor the SiMT task. At each step, the model may evaluate the current input and existing translations to decide whether to provide a translation or wait for additional context. Alternatively, and/or in addition, after integrating the entire translation process, the present disclosure evaluates it in terms of quality and latency. Different from the existing supervised fine-tuning (SFT) technical solutions, the present disclosure does not require prefix-aligned data. Instead, the translation capability and the translation policy prediction capability of the model may be trained in parallel, which avoids label noise in the prefix-aligned data. The experimental results of the present disclosure demonstrate the superiority of the present disclosure, for example, the translation quality may be significantly improved and the translation latency may be reduced.

Specifically, the present disclosure may use a language model (e.g., a large language model) to provide a translation function and a translation policy. Here, the translation policy may specify a part to be translated in a data segment that is currently input. In other words, in the context of the present disclosure, after receiving an input data segment, the part to be translated in the data segment is first determined, and then a translation result corresponding to the part to be translated is provided. In other words, in the step of processing a data segment, no content in the data segment may be translated, only part of the content in the data segment may be translated, or all the content in the data segment may be translated. In this way, the syntax structure of the input text may be determined in a more accurate manner, thereby improving the accuracy of translation.

An overview of an implementation of the present disclosure is described with reference to FIG. 2, which illustrates a block diagram 200 of a translation process for translation from a source language to a destination language according to some implementations of the present disclosure. As shown in FIG. 2, the translation process is described using an example in which the source language is Chinese and the destination language is English. Alternatively, and/or in addition, the source language and the destination language may include other natural languages, such as Japanese, French, German, Spanish, and the like. For ease of discussion, the example in which the data sequence to be translated is in the text format is used, and the data sequence may also be referred to as a text sequence, and the data segment may also be referred to as a text segment. Alternatively, and/or in addition, the data sequence may be represented in other formats, such as an audio format, a video format, and the like. In the translation process, the data sequence represented in the audio or video format may first be converted into a text sequence, and then the machine learning model may be used to perform translation.

According to some implementations of the present disclosure, a data sequence 210 represented in the source language may be received. The data sequence 210 may include one or more data segments, for example, the data segments may be divided according to a predetermined length (e.g., 3, 4, or other values). Alternatively, and/or in addition, the data segments may be divided according to the syntax structure of a sentence, and the like. For ease of illustration, FIG. 2 only shows an example of dividing data segments according to a predetermined length. In this case, each data segment may include three English words.

A data segment may be determined from the data sequence 210, the data segment including at least one data unit 222. Here, the data unit may be a language unit in the source language, for example, an English word. A machine learning model (e.g., model 230) may be used to determine a translation strategy 232 for translating the data segment 220. Here, the translation strategy 232 may indicate a target part (e.g., “despite”) to be translated in the data segment 220. In other words, in the current translation step, for the data segment 220 “despite the pouring”, only “despite” is translated, and “the pouring” is not translated. Then, the machine learning model may be used to determine, based on the translation strategy 232, a translation result 232 corresponding to the target part. At this point, the translation result 234 is represented in the destination language, and “despite” is translated into Chinese “ [symbol] ”.

The present disclosure divides a complete sentence into multiple segments and feeds these segments to the model in a streaming manner to generate partial translations. After the multi-step generation process, the translation results may be integrated. With some implementations of the present disclosure, it is possible to dynamically determine which part of the data segment to be translated based on the data segment input at the current step. In this way, potential errors that may be caused by translating each of the data segments one by one in the order of the source language may be reduced.

Alternatively, and/or in addition, in the model training stage, the present disclosure may use both translation quality and latency as rewards. Through a carefully designed fusion function, the present disclosure may successfully balance the two objectives in the reinforcement learning process. In addition, extensive experiments demonstrate the superiority of the present disclosure, which improves the translation quality and reduces the latency of SiMT.

### Detailed Process of Text Translation

The overview of the translation process has been described, and in the following, more details about the translation will be described. Specifically, the present disclosure converts the process of determining the machine learning model into the process of determining a reward function in reinforcement learning by modeling the SiMT task as a multi-step decision process. For ease of discussion, basic components in reinforcement learning are first defined: an environment and a policy model. The environment and the policy model may interact in real time, and the policy model may be optimized based on the interaction history.

With respect to the environment, a complete source text sequence x=(x₁, x₂, . . . , x_{T}) may be considered, where xᵢ may represent a text segment with k words from the source text sequence. Here, k may have a predetermined value, for example, 3 or other values. At each step, the environment may determine a new text segment from the complete source text sequence and input the new text segment into the policy model. Each of the text segments may be processed one by one until the last text segment is reached, at which point the translation process may end.

With respect to the policy, in the present disclosure, a language model may be used as the policy model π_{θ} in reinforcement learning, and the model may generate a translation result for a new text segment based on the current input text and existing translation results. At time step t, the state [symbol] may be determined based on the previous input text segment and the previous translation result. Assuming that the current input text segment is: x_{1:t}=(x₁, x₂, . . . , xₜ), and the previous translation result is [symbol] _{1:t-1}=( [symbol] ₁, [symbol] ₂, . . . , [symbol] ₜ₋₁). Then the policy model may generate the following translation:

$${y}_{t} = {π}_{θ} ( {s}_{t} ) \qquad ( 1 )$$

Although each text segment xₜ of has a predefined length (e.g., 3 words), the length of [symbol] ₜ may be determined by the policy model. If the policy model determines not to translate the current text segment and waits for more context, no output may be generated. In this case, [symbol] ₜ may be empty and have a length of 0. If the policy model determines to translate the current text segment (e.g., part or all of the current text segment), [symbol] ₜ will include the tokens generated by the policy model. At this point, the untranslated part in the previous step and the current text segment may be combined to output the translation result of the current step. Compared with the existing translation policy of translating text segments with a fixed length one by one, the present disclosure allows the policy model to determine when to start translation and how much content to be translated based on the context. In this way, the policy model of the present disclosure may provide more flexibility than the existing technical solutions and understand the semantics of the text sequence to be translated in a more accurate manner.

With respect to the real-time interaction process, the present disclosure may use a prefix language model as the base model of the policy model. According to some implementations of the present disclosure, the machine learning model may be a language model. A prompt may be determined to invoke the language model to determine the translation strategy and the translation result. Specifically, in the process of determining the translation strategy, a prompt to be input to the language model may be determined based on a prompt template associated with the language model, the data sequence, and previous translation results corresponding to a translated part in the data sequence; and the translation strategy is determined based on a reply of the language model to the prompt. For example, context data of the translation task may be input to the prompt template, so that the language model outputs a translation result that better matches the translation context. Here, the context data may include the translated part in the data sequence, the part to be translated in the current step (i.e., the current data segment), and the previous translation results. Specifically, the policy model may interact with the dynamic environment in a sequential manner, and the specific process is as follows.

(1) The environment may divide the text sequence X into T segments: x=(x₁, x₂, . . . , x_{T}), where T is the number of segments. Assuming that the received text sequence is “Despite the pouring rain, hikers kept going to the top, hoping to catch the sunset”, the above text sequence may be divided into 5 segments: “Despite the pouring”, “rain, hikers kept”, “going to the”, “top, hoping to”, and “catch the sunset”.

(2) In the initial step 1, the environment may determine a first text segment x₁, and based on

$${x}_{1} \text{:} {\hat{y}}_{1}^{i} \sim {π}_{θ} ( {x}_{1} ) ,$$

i=1, . . . , B, based on different translation strategies, the policy model may generate B translations:

$${\hat{y}}_{1}^{i} .$$

For example, the policy model translates the first text segment “Despite the pouring” into Chinese “ [symbol] ”.

According to some implementations of the present disclosure, the target part to be translated in the data segment includes any of the following: empty, a part of the at least one data unit, or all of the at least one data unit. With some implementations of the present disclosure, in the multiple steps of processing the multiple data segments separately, it is not necessary to mechanically translate all the data units in the data segment, instead, the powerful language analysis capability of the machine learning model may be used to selectively not translate any unit, translate some units, or translate all units. In this way, the capability of analyzing the syntax structure of the data sequence to be translated may be improved, thereby providing more accurate translation results.

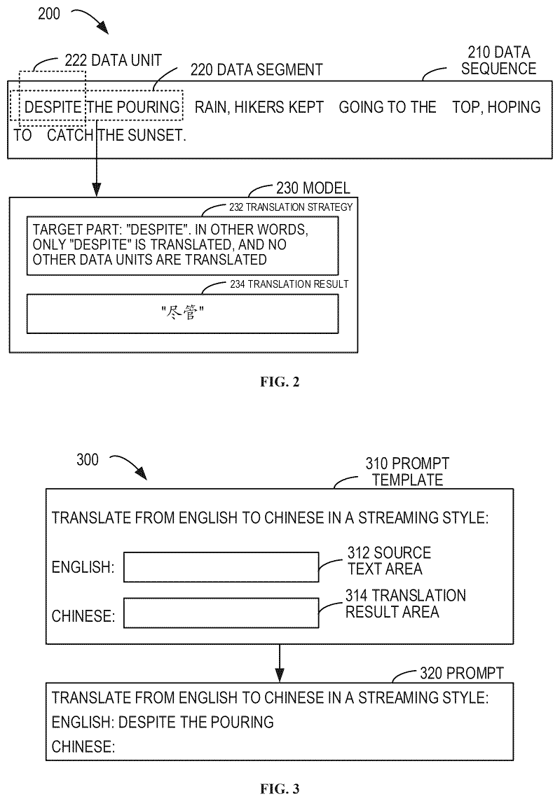

According to some implementations of the present disclosure, the context data of the translation may be inserted into a prompt template to generate a corresponding prompt. FIG. 3 illustrates a block diagram 300 of generation of a prompt using a prompt template according to some implementations of the present disclosure. As shown in FIG. 3, the prompt template 310 may include: a source data area 312 for inputting the translated part in the data sequence and the data segment; and a translation result area 314 for inputting previous translation results corresponding to the translated part.

In the initial stage, because “Despite the pouring” is the first text segment to be translated, there is no translated part at this point. The current text segment “Despite the pouring” may be input to the source text area 312. If there is a translated part, the current text segment may be attached to the translated part. Because there is no previous translation result corresponding to the translated part, the translation result area 314 may be empty at this point, and the prompt 320 may be generated. It may be understood that although the fixed part (e.g., “Translate from English to Chinese in a streaming style”) in the prompt in FIG. 3 is represented in English, alternatively, and/or in addition, depending on the processing capability of the language model, the prompt may be written in other languages, such as Chinese, French, Japanese, German, and the like.

According to some implementations of the present disclosure, the model may determine that the part to be translated in the text segment “Despite the pouring” is “Despite”. At this point, “the pouring” is not translated, instead, the translation result “ [symbol] ” is output. With respect to the untranslated part “the pouring”, a subsequent text segment may be waited for, and the untranslated part and the subsequent text segment may be input to the model together to obtain a more accurate translation result.

(3) In a subsequent step t, the environment may determine a new text segment ft. According to some implementations of the present disclosure, each of the text segments may be processed in a similar manner until the last text segment in the text sequence is processed. In a second step after the first step, a subsequent data segment after the data segment may be determined from the data sequence; and the data segment may be replaced with the subsequent data segment. For example, in the second step after the first step, the second text segment “rain, hikers kept” may be used as the current text segment, and the text segment may be processed according to the process described above. In a third step after the second step, the third text segment “going to the” may be used as the current text segment, and so on. According to some implementations of the present disclosure, each of the text segments may be processed one by one in an iterative manner. In this way, the final translation result may be generated gradually in a plurality of loop steps.

The previous text segment and the current text segment may be connected to obtain (x₁, . . . , xₜ), and the above text content may be input to the source text area 312 in the prompt template 310. Further, the previous translation result ( [symbol] ₁, . . . , [symbol] ₜ₋₁) may be connected, and the translation result area 314 may be filled with the translation result to construct the prompt. Then, the policy model may use formula 1 to generate a translation result based on the current state.

According to some implementations of the present disclosure, in the process of determining the translation result, the translation result may be determined based on the reply of the language model to the prompt. The prompt instructs the machine learning model to determine the translation result corresponding to the target part under a constraint of the previous translation results corresponding to the translated part. With some implementations of the present disclosure, the powerful language processing capability and context understanding capability of the language model may be used to generate more accurate translation results.

In the present disclosure, the source input and the translation are filled into a translation template to construct a prompt for the model to perform translation. For example, in step 2 after initial step 1, the previous text segment “Despite the pouring” and the current text segment “rain, hikers kept” may be connected to obtain the text “Despite the pouring rain, hikers kept”. At this point, the model may determine that the target part to be translated in the text segment “rain, hikers kept” is “rain, hikers”, and “kept” is not translated. The model may obtain the corresponding translation result “ [symbol] , [symbol] ”. At this point, the policy model may follow a similar translation format to translate the policy model, which may translate an incomplete source input into a partial translation result.

According to some implementations of the present disclosure, at least a part of the translation result corresponding to the data sequence may be determined based on the previous translation results corresponding to the translated part in the data sequence and the translation result corresponding to the target part. The translation result corresponding to the target part is added to the previous translation results corresponding to the translated part. Continuing with the above example, the translation result “ [symbol] , [symbol] ” of the current step may be combined with the previous translation result “ [symbol] ” to obtain a translation result “ [symbol] , [symbol] ”. With some implementations of the present disclosure, the process of simultaneously translating a relatively long data sequence may be converted into a process of sequentially translating data segments in the relatively long data sequence, respectively. In this way, a complex translation task of processing, in real time, content to be translated that is received step by step may be converted into a plurality of simple translation tasks, thereby improving the accuracy of the translation result.

(4) The above process may be repeated until t>T. For x=(x₁, x₂, . . . , x_{T}) and y=( [symbol] ₁, [symbol] ₂, . . . , [symbol] ₇), all translation steps may be combined to obtain the final Chinese translation result: “ [symbol] , [symbol] [symbol] , [symbol] ”.

According to some implementations of the present disclosure, the data sequence is received in a streaming manner. It may be understood that the text sequence here may be received in a streaming transmission manner. In this way, the text segments “Despite the pouring”, “rain, hikers kept”, “going to the”, “top, hoping to”, and “catch the sunset” may be received step by step over time. In this way, the newly received content may be processed in real time to provide accurate translation results. Specifically, in a simultaneous translation scenario, a speaker may keep speaking, and the data segments may be determined in a predetermined manner. In a plurality of steps, the newly received data segments may be continuously detected, and the newly received data segments may be processed using the process described above. In this way, translation services may be provided in real time in an accurate and efficient manner.

According to some implementations of the present disclosure, in response to determining that there are no subsequent data segments after the data segment in the data sequence, the above translation method ends. Whether a new data segment is received may be continuously detected, and it is assumed that the speaker stops speaking, at which point the data sequence ends and the translation process may end. Assuming that the speaker continues to speak after a period of time, the method described above may be re-enabled and translation services may be provided. Specifically, the data sequence and the translation result received previously may be provided to the machine learning model as context data, so that the subsequent translation result may better match the previous context. Alternatively, and/or in addition, the machine learning model may be invoked in a new session to provide translation services. For example, the correlation between the newly received data sequence and the previous data sequence may be detected, and in the case that the correlation meets a predetermined threshold condition, a new session may be started. In this way, corresponding translations may be provided for different contexts, thereby improving the accuracy of the translation result.

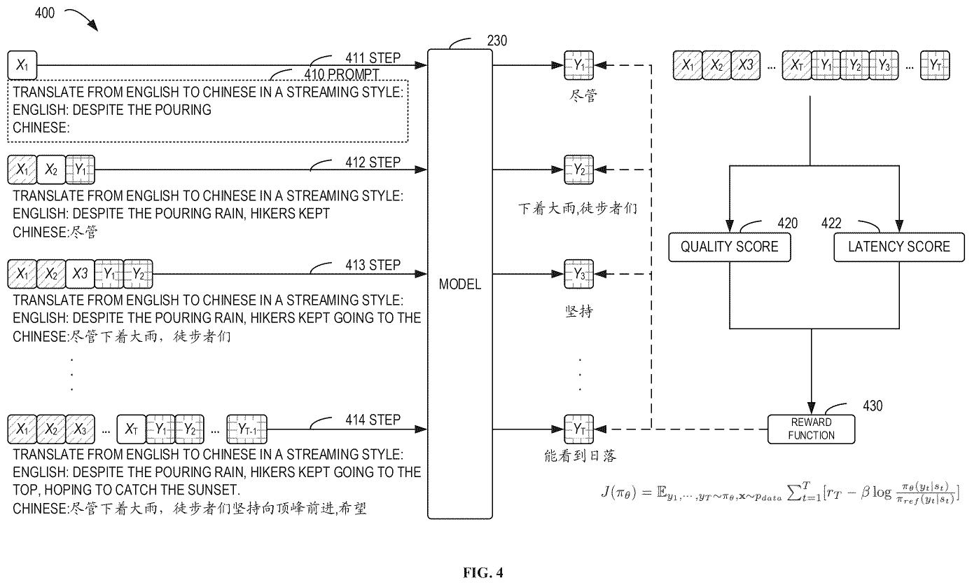

The steps of the translation process have been described separately, and in the following, more details of the entire translation process are described with reference to FIG. 4. FIG. 4 illustrates a block diagram 400 of a translation process performed in a plurality of steps in accordance with some implementations of the present disclosure. As shown in FIG. 4, as time goes by, data segments x₁ to x_{T} may be received step by step in each of the steps. In step 411, x₁ represents “Despite the pouring”, and at this point there is no previous translation result, so x₁ and empty may be filled in two parts of the prompt 410, respectively. The model 230 may receive the prompt and generate a translation result y₁ (i.e., “ [symbol] ” in Chinese) for the data segment x₁.

In step 412, x₂ represents “rain, hikers kept”, and at this point there is a previous translation result y₁, so x₁x₂ and y₁ may be filled in two parts of the prompt, respectively. The model 230 may receive the prompt and generate a translation result y₂ for the data segment x₂.

In step 413, x₃ represents “going to the”, and at this point there are previous translation results y₁ and y₂, so x₁x₂x₃ and y₁y₂ may be filled in two parts of the prompt, respectively. The model 230 may receive the prompt and generate a translation result y₃ for the data segment x₃.

Similar operations may be performed in subsequent steps, and in the last step 414, x_{T} (T=5) represents “catch the sunset”, and at this point there are previous translation results y₁ to y_{T-1}, so x₁x₂x₃ . . . x_{T} and y₁y₂ . . . y_{T-1} may be filled in two parts of the prompt, respectively. The model 230 may receive the prompt and generate a translation result y_{T} for the data segment x_{T}. The translation process ends here, and the final translation result is “ [symbol] [symbol] , [symbol] [symbol] , [symbol] ” in Chinese.

According to some implementations of the present disclosure, the machine learning model described above may be a pre-trained model. The right side of FIG. 4 shows the process of training the machine learning model. In summary, the overall reward function 430 may be determined after the translation of the entire text sequence (e.g., the entire sentence) is completed. Here, the reward function 430 may be constructed using both the quality score 420 and the latency score 422. The quality score 420 may represent the quality of the translation result, for example, including but not limited to various aspects such as accuracy, fluency, and completeness. The latency score 422 may represent the time latency in the translation process. Because simultaneous translation requires the translation result to be provided synchronously, it is desired that the time latency be as low as possible to ensure that the audience may understand the intention of the speaker in time.

According to some implementations of the present disclosure, the model may be determined based on the following: obtaining a reference sample, the reference sample including a reference source data sequence in the source language and a reference destination data sequence in the destination language; determining a reference translation result of the reference source data sequence using the machine learning model; determining a reward function based on at least one of translation quality or translation latency associated with the reference translation result; and updating the machine learning model based on the reward function.

With respect to the reward function, both the quality and the latency of the translation result may change during the interaction process. At the end of the SiMT process, the policy model π_{θ} reward may be given. After the translation is completed, the existing measurement model for machine translation may be used to evaluate the translation quality. The latency may also be calculated based on the average lagging. The present disclosure evaluates the final translation based on the translation quality and the latency. In other words, at the last step T, an accurate final reward may be provided to the policy model π_{θ}, and the policy model may use r_{T} to optimize its sequential decision from step 1 to step T.

The objective of the present disclosure is to achieve high-quality and low-latency translation success. However, there is an inevitable trade-off between translation quality and latency: a conservative policy of waiting longer may have higher translation, while an aggressive policy with a small latency may lack translation quality. In order to balance these two metrics and unify them to the same scale, the present disclosure proposes a fusion reward to measure quality and latency. In the process of determining the reward function, a weight factor for describing the weights of the translation quality and the translation latency may be received; and the reward function is determined based on the translation quality, the translation latency and the weight factor. Specifically, the present disclosure defines the reward as follows:

$${\hat{q}}^{i} = \hat{q} ( {x}^{i} , {y}^{i} ) \qquad ( 2 )$$

$${\hat{L}}^{i} = \hat{L} ( {x}^{i} , {y}^{i} )$$

$${q}^{i} = \frac{{\hat{q}}^{i} - mean ( {\hat{q}}^{1} , ⋯ , {\hat{q}}^{B} )}{std ( {\hat{q}}^{1} , ⋯ , {\hat{q}}^{B} )}$$

$${L}^{i} = min ( k , \frac{{\hat{L}}^{i} - mean ( {\hat{L}}^{1} , ⋯ , {\hat{L}}^{B} )}{std ( {\hat{L}}^{1} , ⋯ , {\hat{L}}^{B} )} )$$

$${r}_{T}^{i} = λ {q}^{i} - {L}^{i}$$

In the above formula, λ represents a hyperparameter, which determines the balance between quality and latency, and the superscript i represents the ith sample in the batch. \hat{q} represents a translation quality measurement parameter, \hat{L} represents a measurement parameter of the latency, x represents a sequence (e.g., a sentence) written in the source language, y represents the translation result, and B represents the number of sampling paths. In the above equation, the values of quality and latency may be standardized because they have different scales. Through the normalization process, these two indicators may be converted to the same scale, making them easier to compare and evaluate together. L may be truncated to prevent overfitting the latency score. In addition to the reward, a KL constraint may be provided to keep the policy model stable during the training process. Therefore, the final objective function of the model may be expressed as:

$$J ( {π}_{θ} ) = {𝔼}_{{y}_{1} , ⋯ , {y}_{T} \sim {π}_{θ} ( \cdot ) , x \sim {p}_{data}} {\sum }_{t = 1}^{T} [ {r}_{T} - β log \frac{{π}_{θ} ( {y}_{t} \vert {s}_{t} )}{{π}_{ref} ( {y}_{t} \vert {s}_{t} )} ]$$

According to some implementations of the present disclosure, a known language model may be used to determine the specific value of the translation quality \hat{q}, for example, a prompt may be constructed to call the language model to output the quality score. For example, an example of the prompt may be shown in Table 1:

TABLE 1
Example of a prompt

Please provide a quality score for the translation from <SOURCE_LANG> to <DESTINATION_LANG>,
with a range from 0 to 100, where 0 represents “nonsensical” and 100 represents perfect meaning and
grammar. [symbol]
<SOURCE_LANG> Source: <SOURCE_SENTENCE> [symbol]
<TARGET_LANG> Target: <DESTINATION_SENTENCE> [symbol]
Provide the score numerically. Do not include any other information.

[symbol]

The source language and the destination language, for example, “English” and “Chinese”, may be filled in <SOURCE_LANG> and <DESTINATION_LANG> shown in Table 1, respectively; the sentence to be translated may be filled in <SOURCE_SENTENCE>, the translation result to be evaluated may be filled in <DESTINATION SENTENCE>, and the score of the translation quality in the range of 0 to 100 may be obtained.

According to some implementations of the present disclosure, the translation latency may be determined using the difference between inputting the text segment to be translated and receiving the translation result for the text segment. Alternatively, and/or in addition, the overall translation latency may be determined based on the translation latency of multiple text segments.

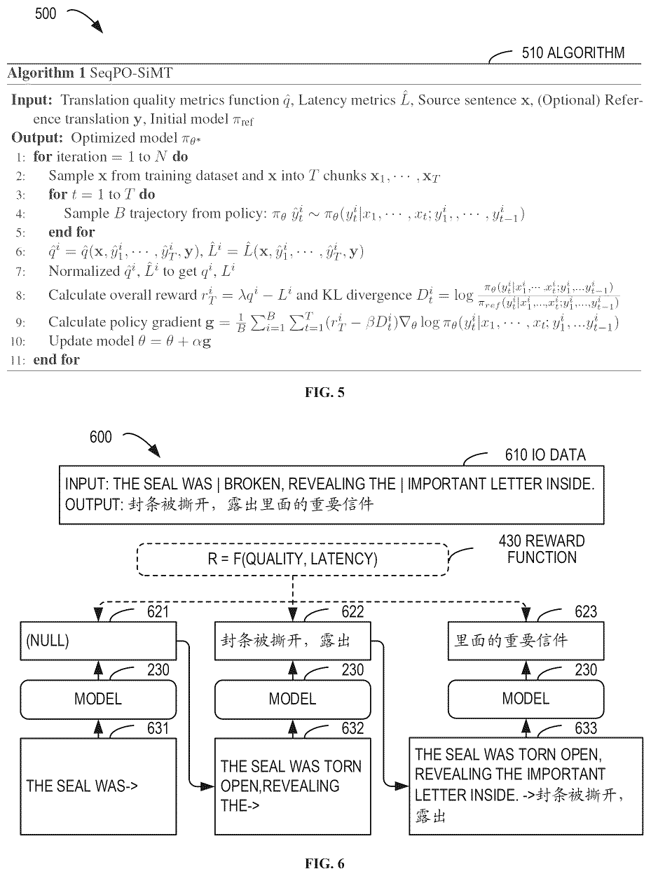

More details about the training process are described with reference to FIG. 5, which illustrates a block diagram 500 of training a machine learning model in accordance with some implementations of the present disclosure. It should be understood that FIG. 5 shows the specific update algorithm of the model in pseudo-code, and the specific training process may be adjusted based on the specific development environment. As shown in the algorithm 510, the input data of the model update process includes: \hat{q}, representing the translation quality measurement parameter; \hat{L}, representing the measurement parameter of the latency, x, representing a sequence (e.g., a sentence) written in the source language; y, representing a reference translation (optional); and π_{ref}, representing the initial model. The output data of the model update process includes: π_{θ}*, i.e., the optimized model. The update process involves multiple parameters, including: xᵢ, representing a text segment written in the source language; k, representing the number of text units in each text segment; [symbol] ᵢ, representing the translation result for xᵢ; π_{θ}, representing the model.

As shown in FIG. 5, at line 1: the update process may be performed repeatedly, for example, N times repeatedly using different training samples. At line 2: x may be sampled from the training dataset and x may be divided into T text segments. At lines 3-5: each of the text segments may be processed in a similar manner, and multiple translation results from multiple (e.g., B) sampling paths may be obtained. At line 6: the quality measurement parameter \hat{q}ⁱ and the latency measurement parameter \hat{L}ⁱ in the ith iteration round may be determined using the multiple translation results. At line 7: normalization may be performed for the quality measurement parameter \hat{q}ⁱ and the latency measurement parameter \hat{L}ⁱ to determine qⁱ and Lⁱ. At line 8, the overall reward function and the KL divergence may be calculated. At line 9: the update gradient g may be calculated. It should be understood that the KL divergence here is used to ensure the stability of the model update process. Alternatively, and/or in addition, the KL divergence may be ignored. At line 10: the model may be updated. Here, a represents a predetermined hyperparameter, and the value of the hyperparameter may be set according to a specific application environment.

According to some implementations of the present disclosure, the reference translation result includes multiple reference translation results corresponding to multiple sampling trajectories of the machine learning model. In the process of determining the translation quality, multiple translation quality components corresponding to the multiple reference translation results, respectively, may be determined. Specifically, multiple reference translation results may be determined based on multiple sampling paths, respectively, and then the corresponding quality components may be determined. Further, the translation quality may be determined based on the multiple translation quality components. For example, the translation quality may be determined based on the multiple quality components using the formulas in lines 6-7 in the algorithm 510. In this way, the translation quality may be measured in a more accurate manner. According to some implementations of the present disclosure, the translation latency may be determined in a similar manner. In the process of determining the translation latency, multiple translation latency components corresponding to the multiple reference translation results, respectively, may be determined; and the translation latency is determined based on the multiple translation latency components. For example, the translation latency may be determined based on the multiple latency components using the formulas in lines 6-7 in the algorithm 510. In this way, the translation quality may be measured in a more accurate manner.

It should be understood that although FIG. 5 shows the case where only one training sample is used in one batch, alternatively and/or in addition, the model may be trained based on batch processing. In this case, multiple training samples may be used in each batch to determine the reward function and then determine the update gradient, which will not be repeated in the present disclosure.

According to some implementations of the present disclosure, the model may be updated using the determined update gradient. Since the model has the capabilities of determining both the translation strategy and the translation result, the updated model may affect the translation strategy and the translation result in each model invocation (i.e., each translation step). For example, a more aggressive translation strategy (e.g., translating more content) may be adopted in a certain translation step and the translation result may be output; a more conservative translation strategy (e.g., translating less content and waiting for subsequent text input) may be adopted in a certain step and the translation result may be output, and the like.

According to some implementations of the present disclosure, the above model may be optimized. For example, the optimization may be performed using the Group Relative Policy Optimization (GRPO) method. The present disclosure may sample B trajectories and calculate the reward for each trajectory. In this way, in terms of resource efficiency, the present disclosure may use the group average value as its baseline.

With respect to the model and the training settings, in the context of the present disclosure, taking Chinese-to-English and English-to-Chinese as specific examples of translation, the currently known public translation dataset may be used as training data. A known language model may be used as the base model, and the base model may be trained to obtain the SiMT capability. Specifically, a predetermined number (e.g., 40,000) of samples may be constructed for warm-up. A predetermined number of samples may be randomly selected from the training dataset and the partial translation data may be constructed through the prompt. Then, the remaining data samples may be used to train the language model.

With respect to the evaluation metrics, in order to effectively verify the effectiveness of the translation framework of the present disclosure, experiments may be performed on datasets in different fields (e.g., including informal scenarios, professional scenarios, news scenarios, and the like). For example, the Bilingual Evaluation Understudy (BLEU) may be used. The BLEU score is one of the most commonly used evaluation metrics in the field of machine translation and is used to measure the quality of the translated text. It evaluates the accuracy of the translation by comparing the similarity between the translation generated by the model and the reference translation. Alternatively, and/or in addition, other metrics may be used to evaluate the translation quality, and in this way, the quality of the translation result may be evaluated from multiple aspects.

According to some implementations of the present disclosure, the specific value of the hyperparameter may be determined, for example, 50 SIMT samples may be sampled and different values of λ may be set. Alternatively, and/or in addition, λ=2 may be selected to balance the translation quality and the latency. For other hyperparameters, for example, for the English-to-Chinese task, B=5, β=0.02 may be set; for the Chinese-to-English task, β=0.1 may also be set. Alternatively, and/or in addition, the hyperparameters may be set to other values.

The specific parameters of the model may be set, and the model may be updated using the training process described above. Further, the updated model may be used to perform the translation process, and another translation process is described with reference to FIG. 6. FIG. 6 illustrates a block diagram 600 of determining a translation result using a machine learning model in accordance with some implementations of the present disclosure. As shown in FIG. 6, the IO data 610 indicates that the input sentence to be translated is “The seal was broken, revealing the important letter inside”. For ease of illustration, the vertical line “|” is used to divide the entire sentence into multiple segments “The seal was”, “broken, revealing the”, and “important letter inside”. The final output translation result is: “ [symbol] , [symbol] [symbol] ”.

As shown in FIG. 6, the model may be trained using the reward function 430, and the translated context data may be input to the trained model. Specifically, in the left step, the segment 631 and the previous translation result 621 (empty) may be input to the model 230. The model 230 chooses to wait for the subsequent segment and does not output a translation result. In the middle step, the segment 632 and the previous translation result (empty) may be input to the model 230. The model 230 outputs the translation result 622 (“ [symbol] , [symbol] ”). In the right step, the segment 633 and the previous translation result (“ [symbol] , [symbol] ”) may be input to the model 230. The model 230 outputs the translation result 623 (“ [symbol] [symbol] ”). The final output translation result is: “ [symbol] , [symbol] [symbol] ”. By using some implementations of the present disclosure, the translation result of “The seal was” is not directly output in the initial step, but the subsequent input segment is waited for. In this way, the translation accuracy may be improved.

The performance of the model of the present disclosure and the online simultaneous interpretation translation model may be compared on multiple test datasets. Experiments show that the technical solution of the present disclosure may achieve higher translation quality for different latency levels. Compared with the translation technical solution of the rule-based read/write policy, the technical solution of the present disclosure may intelligently decide whether to wait for more context or translate the current text segment. Compared with the existing offline translation models, the translation model of the present disclosure is better than the existing offline SFT models. In order to make the evaluation results more accurate, the existing language model is used as an evaluator for evaluating the translation quality to score the translation results of different models. Because the offline method has more detailed contextual information, the offline translation result is usually better than SiMT. The translation quality of the translation model of the present disclosure is close to that of the offline model, and experiments show that the technical solution of the present disclosure not only achieves lower latency, but also improves the translation quality.

With respect to the balance between quality and latency, the present disclosure may obtain better performance in both translation quality and latency, thereby achieving higher translation quality. When only optimizing the translation quality, that is, in the case of r=qⁱ, the highest achievable translation quality is achieved. The experimental results show that the translation model of the present disclosure may achieve lower latency than the base model. In addition, during offline translation, the translation model of the present disclosure may achieve comparable translation quality to the base translation model.

By using some implementations of the present disclosure, the proposed model accesses SiMT data during the training process, which enables it to better adapt to the complex and dynamic simulated translation scenarios. Experiments show that the present disclosure may significantly improve the translation quality and may even achieve a quality that closely matches offline translation with minimized latency.

### Example Process

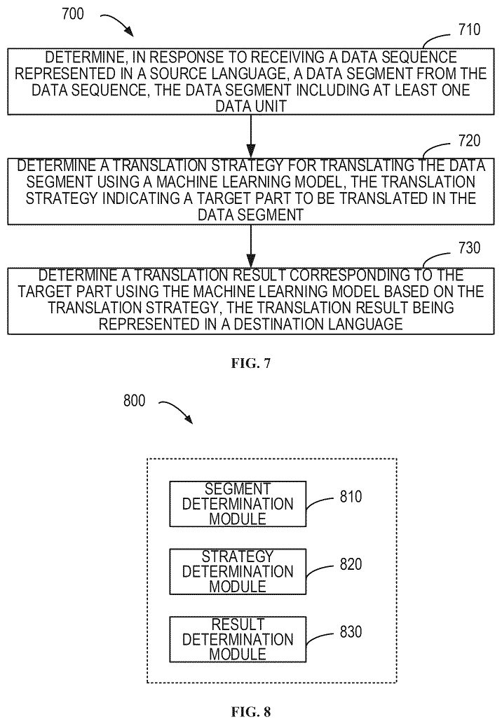

FIG. 7 illustrates a flowchart of a method 700 for translation from a source language to a destination language in accordance with some implementations of the present disclosure. At block 710, in response to receiving a data sequence represented in the source language, a data segment is determined from the data sequence, the data segment including at least one data unit. At block 720, a translation strategy for translating the data segment is determined using a machine learning model, the translation strategy indicating a target part to be translated in the data segment. At block 730, a translation result corresponding to the target part is determined using the machine learning model based on the translation strategy, the translation result being represented in the destination language.

According to some implementations of the present disclosure, the target part in the data segment to be translated includes any of the following: empty, a part of the at least one data unit, or all of the at least one data unit.

According to some implementations of the present disclosure, the machine learning model is a language model, and determining the translation strategy includes: determining a prompt to be input to the language model based on a prompt template associated with the language model, the data sequence, and a previous translation result corresponding to a translated part in the data sequence; and determining the translation strategy based on a reply of the language model to the prompt.

According to some implementations of the present disclosure, the prompt template includes: a source data area for inputting the translated part in the data sequence and the data segment, and a translation result area for inputting the previous translation result corresponding to the translated part.

According to some implementations of the present disclosure, determining the translation result includes: determining the translation result based on the reply of the language model to the prompt, the prompt instructing the machine learning model to determine the translation result corresponding to the target part under a constraint of the previous translation result corresponding to the translated part.

According to some implementations of the present disclosure, the method further includes: determining at least a part of the translation result corresponding to the data sequence based on the previous translation result corresponding to the translated part in the data sequence and the translation result corresponding to the target part; and adding the translation result corresponding to the target part to the previous translation result corresponding to the translated part.

According to some implementations of the present disclosure, the method is performed in a first step in a translation process for translating the data sequence, and the method further includes: in a second step after the first step, determining, from the data sequence, a subsequent data segment after the data segment; and replacing the data segment with the subsequent data segment.

According to some implementations of the present disclosure, the method further includes: ending the method in response to determining that there is no subsequent data segment after the data segment in the data sequence.

According to some implementations of the present disclosure, the machine learning model is determined based on the following: obtaining a reference sample, the reference sample including a reference source data sequence in the source language and a reference destination data sequence in the destination language; determining a reference translation result of the reference source data sequence using the machine learning model; determining a reward function based on at least one of translation quality or translation latency associated with the reference translation result; and updating the machine learning model based on the reward function.

According to some implementations of the present disclosure, determining the reward function includes: receiving a weight factor for describing weights of the translation quality and the translation latency; and determining the reward function based on the translation quality, the translation latency, and the weight factor.

According to some implementations of the present disclosure, the reference translation result includes multiple reference translation results corresponding to multiple sampling trajectories of the machine learning model, and the translation quality is determined based on the following: determining multiple translation quality components corresponding to the multiple reference translation results, respectively; and determining the translation quality based on the multiple translation quality components.

According to some implementations of the present disclosure, the translation latency is determined based on the following: determining multiple translation latency components corresponding to the multiple reference translation results, respectively; and determining the translation latency based on the multiple translation latency components.

According to some implementations of the present disclosure, the data sequence is received in a streaming manner.

### Example Apparatus and Device

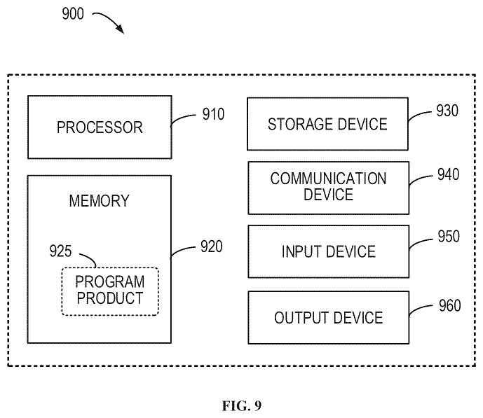

FIG. 8 illustrates a block diagram of an apparatus 800 for translation from a source language to a destination language in accordance with some implementations of the present disclosure. The apparatus includes: a segment determination module 810 configured to, in response to receiving a data sequence represented in the source language, determine a data segment from the data sequence, the data segment including at least one data unit; a strategy determination module 820 configured to determine a translation strategy for translating the data segment using a machine learning model, the translation strategy indicating a target part to be translated in the data segment; and a result determination module 830 configured to determine a translation result corresponding to the target part using the machine learning model based on the translation strategy, the translation result being represented in the destination language.

According to some implementations of the present disclosure, the target part in the data segment to be translated includes any of the following: empty, a part of the at least one data unit, or all of the at least one data unit.

According to some implementations of the present disclosure, the machine learning model is a language model, and the strategy determination module is further configured to: determine a prompt to be input to the language model based on a prompt template associated with the language model, the data sequence, and a previous translation result corresponding to a translated part in the data sequence; and determine the translation strategy based on a reply of the language model to the prompt.

According to some implementations of the present disclosure, the prompt template includes: a source data area for inputting the translated part in the data sequence and the data segment; and a translation result area for inputting the previous translation result corresponding to the translated part.

According to some implementations of the present disclosure, the result determination module is further configured to: determine the translation result based on the reply of the language model to the prompt, the prompt instructing the machine learning model to determine the translation result corresponding to the target part under a constraint of the previous translation result corresponding to the translated part.

According to some implementations of the present disclosure, the result determination module is further configured to: determine at least a part of the translation result corresponding to the data sequence based on the previous translation result corresponding to the translated part in the data sequence and the translation result corresponding to the target part; and add the translation result corresponding to the target part to the previous translation result corresponding to the translated part.

According to some implementations of the present disclosure, the apparatus is invoked in a first step in a translation process for translating the data sequence, and the apparatus further includes a processing module configured to: in a second step after the first step, determine, from the data sequence, a subsequent data segment after the data segment; and replace the data segment with the subsequent data segment.

According to some implementations of the present disclosure, the processing module is further configured to: end the method in response to determining that there is no subsequent data segment after the data segment in the data sequence.

According to some implementations of the present disclosure, the apparatus further includes a training module configured to: obtain a reference sample, the reference sample including a reference source data sequence in the source language and a reference destination data sequence in the destination language; determine a reference translation result of the reference source data sequence using the machine learning model; determine a reward function based on at least one of translation quality or translation latency associated with the reference translation result; and update the machine learning model based on the reward function.

According to some implementations of the present disclosure, the training module is further configured to: receive a weight factor for describing weights of the translation quality and the translation latency; and determine the reward function based on the translation quality, the translation latency, and the weight factor.

According to some implementations of the present disclosure, the training module is further configured to the reference translation result including multiple reference translation results corresponding to multiple sampling trajectories of the machine learning model, and the translation quality is determined based on the following: determining multiple translation quality components corresponding to the multiple reference translation results, respectively; and determining the translation quality based on the multiple translation quality components.

According to some implementations of the present disclosure, the translation latency is determined based on the following: determining multiple translation latency components corresponding to the multiple reference translation results, respectively; and determining the translation latency based on the multiple translation latency components.

According to some implementations of the present disclosure, the data sequence is received in a streaming manner.

FIG. 9 illustrates a block diagram of a device 900 capable of implementing a plurality of implementations of the present disclosure. It may be understood that the computing device 900 shown in FIG. 9 is only illustrative and should not constitute any limitation on the functionalities and the scope of implementations described herein. The computing device 900 shown in FIG. 9 may be used to implement the method described above.

As shown in FIG. 9, the computing device 900 is in the form of a general-purpose computing device. Components of the computing device 900 may include, but are not limited to, one or more processors 910, a memory 920, a storage device 930, one or more communication devices 940, one or more input devices 950, and one or more output devices 960. The processor 910 may be a physical or virtual processor and may perform various processes based on the programs stored in the memory 920. In a multi-processor system, multiple processors perform computer executable instructions in parallel to improve the parallel processing capability of the computing device 900.

The computing device 900 typically includes multiple computer storage medium. Such medium may be any available medium accessible by the computing device 900, including but not limited to volatile and non-volatile medium, removable and non-removable medium. The memory 920 may be volatile memory (e.g., a register, cache, a random access memory (RAM)), a non-volatile memory (such as a read-only memory (ROM), an electrically erasable programmable read-only memory (EEPROM), a flash memory), or any combination thereof. The storage device 930 may be any removable or non-removable medium, and may include a machine-readable medium such as a flash drive, a disk, or any other medium, which may be used to store information and/or data (such as training data for training) and may be accessed within the computing device 900.

The computing device 900 may further include additional removable/non-removable, volatile/non-volatile memory medium. Although not shown in FIG. 9, a disk driver for reading from or writing into removable and non-volatile disks (such as a “floppy disk”), and an optical disk driver for reading from or writing into removable and non-volatile optical disks may be provided. In these cases, each driver may be connected to the bus (not shown) by one or more data medium interfaces. The memory 920 may include a computer program product 925 having one or more program modules configured to perform various methods or acts of various implementations of the present disclosure.

The communication unit 940 enables communication with other computing devices through the communication medium. In addition, the functions of the components of the computing device 900 may be implemented by a single computing cluster or multiple computing machines, which may communicate through communication connections. Therefore, the computing device 900 may use a logical connection with one or more other servers, a network personal computer (PC), or another network node to operate in a networked environment.

The input device 950 may be one or more input devices, such as a mouse, a keyboard, a tracking ball, etc. The output device 960 may be one or more output devices, such as a display, a speaker, a printer, etc. The computing device 900 may also communicate with one or more external devices (not shown) through the communication unit 940 as needed, the external devices such as a storage device, a display device, etc., communicate with one or more devices that enable the user to interact with the computing device 900, or communicate with any devices (such as a network card, a modem, etc.) that enable the computing device 900 to communicate with one or more other computing devices. Such communication may be performed via input/output (I/O) interfaces (not shown).

According to an implementation of the present disclosure, there is provided a computer-readable storage medium having computer executable instructions stored thereon, the computer executable instructions being executed by a processor to implement the method described above. According to an implementation of the present disclosure, there is further provided a computer program product tangibly stored on a non-transitory computer-readable medium and including computer-executable instructions, the computer-executable instructions being executed by a processor to implement the method described above. According to an implementation of the present disclosure, there is provided a computer program product having a computer program stored thereon, the program, when executed by a processor, implementing the method described above.

Various aspects of the present disclosure are described herein with reference to flowcharts and/or block diagrams of methods, apparatuses, devices, and computer program products implemented according to the present disclosure. It may be understood that each block of the flowcharts and/or block diagrams, and combinations of blocks in the flowcharts and/or block diagrams, may be implemented by computer-readable program instructions.

These computer-readable program instructions may be provided to a processor of a general-purpose computer, a special-purpose computer, or other programmable data processing apparatuses to produce a machine, such that when the instructions are executed by the processor of the computer or other programmable data processing apparatuses, an apparatus for implementing the functions/acts specified in one or more blocks of the flowcharts and/or block diagrams is produced. These computer-readable program instructions may also be stored in a computer-readable storage medium, which instructions cause the computer, the programmable data processing apparatus, and/or other devices to operate in a specific manner, and the computer-readable medium having the instructions stored therein includes an article of manufacture including instructions for implementing various aspects of the functions/acts specified in one or more blocks of the flowcharts and/or block diagrams.

The computer-readable program instructions may be loaded onto a computer, other programmable data processing apparatuses, or other devices, such that a series of operating steps are performed on the computer, other programmable data processing apparatuses, or other devices to produce a computer-implemented process, such that the instructions executed on the computer, other programmable data processing apparatuses, or other devices implement the functions/acts specified in one or more blocks of the flowcharts and/or block diagrams.

The flowcharts and block diagrams in the drawings illustrate the possibly implemented architectures, functionalities, and operations of the systems, methods and computer program products according to a plurality of implementations of the present disclosure. In this regard, each block in the flowcharts or block diagrams may represent a module, a program segment, or a portion of instructions, which module, program segment, or portion of instructions contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It would also be noted that each block of the block diagrams and/or flowcharts, and combinations of the blocks in the block diagrams and/or flowcharts, may be implemented in special purpose hardware-based systems that perform the specified functions or acts, or in combinations of special purpose hardware and computer instructions.

The implementations of the present disclosure have been described above, and the above description is illustrative, not exhaustive, and is not limited to the disclosed implementations. Many modifications and variations will be apparent to those of ordinary skill in the art without departing from the scope of the described implementations. The choice of terms used herein is intended to best explain the principles, practical applications, or improvements to the technology in the market of the implementations, or to enable other people of ordinary skill in the art to understand the implementations disclosed herein.

1. A method for translation from a source language to a destination language, comprising:
determining, in response to receiving a data sequence represented in the source language, a data segment from the data sequence, the data segment comprising at least one data unit;
determining a translation strategy for translating the data segment using a machine learning model, the translation strategy indicating a target part to be translated in the data segment; and
determining a translation result corresponding to the target part using the machine learning model based on the translation strategy, the translation result being represented in the destination language.

2. The method of claim 1, wherein the target part to be translated in the data segment comprises any of the following: empty, a part of the at least one data unit, or all of the at least one data unit.

3. The method of claim 1, wherein the machine learning model is a language model, and determining the translation strategy comprises:
determining a prompt to be input to the language model based on a prompt template associated with the language model, the data sequence, and a previous translation result corresponding to a translated part in the data sequence; and
determining the translation strategy based on a reply of the language model to the prompt.

4. The method of claim 3, wherein the prompt template comprises:
a source data area for inputting the translated part in the data sequence and the data segment, and
a translation result area for inputting the previous translation result corresponding to the translated part.

5. The method of claim 3, wherein determining the translation result comprises: determining the translation result based on the reply of the language model to the prompt, the prompt instructing the machine learning model to determine a translation result corresponding to the target part under a constraint of the previous translation result corresponding to the translated part.

6. The method of claim 1, further comprising:
determining at least a part of a translation result corresponding to the data sequence based on a previous translation result corresponding to a translated part in the data sequence and the translation result corresponding to the target part; and
adding the translation result corresponding to the target part to the previous translation result corresponding to the translated part.

7. The method of claim 6, wherein the method is performed in a first step in a translation process for translating the data sequence, and the method further comprises:
determining, in a second step after the first step, a subsequent data segment after the data segment from the data sequence; and
replacing the data segment with the subsequent data segment.

8. The method of claim 7, further comprising: ending the method in response to determining that there is no subsequent data segment after the data segment in the data sequence.

9. The method of claim 1, wherein the machine learning model is determined based on the following:
obtaining a reference sample, the reference sample comprising a reference source data sequence represented by the source language and a reference destination data sequence represented by the destination language;
determining a reference translation result of the reference source data sequence using the machine learning model;
determining a reward function based on at least one of translation quality or translation latency associated with the reference translation result; and
updating the machine learning model based on the reward function.

10. The method of claim 9, wherein determining the reward function comprises:
receiving weight factors for describing weights of the translation quality and the translation latency; and
determining the reward function based on the translation quality, the translation latency, and the weight factors.

11. The method of claim 9, wherein the reference translation result comprises a plurality of reference translation results corresponding to a plurality of sampling trajectories of the machine learning model, and the translation quality is determined based on the following:
determining a plurality of translation quality components corresponding to the plurality of reference translation results, respectively; and
determining the translation quality based on the plurality of translation quality components.

12. The method of claim 11, wherein the translation latency is determined based on the following:
determining a plurality of translation latency components corresponding to the plurality of reference translation results, respectively; and
determining the translation latency based on the plurality of translation latency components.

13. The method of claim 1, wherein the data sequence is received in a streaming manner.

14. An electronic device, comprising:
at least one processor; and
at least one memory, the at least one memory being coupled to the at least one processor and storing instructions for execution by the at least one processor, the instructions, when executed by the at least one processor, causing the electronic device to perform acts comprising:
determining, in response to receiving a data sequence represented in the source language, a data segment from the data sequence, the data segment comprising at least one data unit;
determining a translation strategy for translating the data segment using a machine learning model, the translation strategy indicating a target part to be translated in the data segment; and
determining a translation result corresponding to the target part using the machine learning model based on the translation strategy, the translation result being represented in the destination language.

15. A non-transitory computer-readable storage medium having computer instructions stored thereon, the computer instructions, when executed by a processor, causing the processor to implement acts comprising:
determining, in response to receiving a data sequence represented in the source language, a data segment from the data sequence, the data segment comprising at least one data unit;
determining a translation strategy for translating the data segment using a machine learning model, the translation strategy indicating a target part to be translated in the data segment; and
determining a translation result corresponding to the target part using the machine learning model based on the translation strategy, the translation result being represented in the destination language.

16. The non-transitory computer-readable storage medium of claim 15, wherein the target part to be translated in the data segment comprises any of the following: empty, a part of the at least one data unit, or all of the at least one data unit.

17. The non-transitory computer-readable storage medium of claim 15, wherein the machine learning model is a language model, and determining the translation strategy comprises:
determining a prompt to be input to the language model based on a prompt template associated with the language model, the data sequence, and a previous translation result corresponding to a translated part in the data sequence; and
determining the translation strategy based on a reply of the language model to the prompt.

18. The non-transitory computer-readable storage medium of claim 17, wherein the prompt template comprises:
a source data area for inputting the translated part in the data sequence and the data segment, and
a translation result area for inputting the previous translation result corresponding to the translated part.

19. The non-transitory computer-readable storage medium of claim 17, wherein determining the translation result comprises: determining the translation result based on the reply of the language model to the prompt, the prompt instructing the machine learning model to determine a translation result corresponding to the target part under a constraint of the previous translation result corresponding to the translated part.

20. The non-transitory computer-readable storage medium of claim 15, wherein the acts further comprise:
determining at least a part of a translation result corresponding to the data sequence based on a previous translation result corresponding to a translated part in the data sequence and the translation result corresponding to the target part; and
adding the translation result corresponding to the target part to the previous translation result corresponding to the translated part.
